(19) United States
(12) Patent Application Publication
(10) Pub. No.: US 2014/0300438 A1
(43) Pub. Date: Oct. 9, 2014

(54) Transformer and Associated Production Method

(71) Applicants: Dirk Schekulin, Arbon (CH); Silvia Gross-Kaeufler, Romanshorn (CH); Chriss Haertsch, Flawil (CH); Thomas Bisig, Romanshorn (CH); Alex Itten, Romanshorn (CH); Piere Cavin, Weinfelden (CH)

(72) Inventors: Dirk Schekulin, Arbon (CH); Silvia Gross-Kaeufler, Romanshorn (CH); Chriss Haertsch, Flawil (CH); Thomas Bisig, Romanshorn (CH); Alex Itten, Romanshorn (CH); Piere Cavin, Weinfelden (CH)

(73) Assignee: Schmidhauser AG, Romanshorn (CH)

(21) Appl. No.: 14/342,517

(22) PCT Filed: Aug. 20, 2012
(86) PCT No.: PCT/EP2012/066207

§ 371 Date: May 15, 2014

(30) Foreign Application Priority Data
Sep. 2, 2011 (DE) 10 2011 082 046.9

(51) Int. Cl. H01F 27/08; H01F 27/34; H01F 41/04; H01F 27/28

(52) U.S. Cl. CPC H01F 27/085; H01F 27/2876; H01F 27/346; H01F 41/04
USPC 336/61; 336/220; 29/602.1

(57) ABSTRACT

A transformer for switched-mode power supplies includes a magnetizable core having a winding axis, at least one primary winding, which is formed by a primary winding conductor which at least partly surrounds the winding axis of the core, and at least one secondary winding, which is formed by a secondary winding conductor. The secondary winding conductor surrounds the primary winding conductor. The secondary winding is formed in one layer, and a cross section of the secondary winding conductor is rectangular, in particular square.

### BACKGROUND AND SUMMARY OF THE INVENTION

The invention relates to a transformer and an associated production method.

High-frequency transformers for high output currents are predominantly planar constructions with stamped laminations for the secondary winding. The primary winding is usually likewise laminated or is also produced with stranded wire.

The correct electrical connection of the laminations to one another is associated with high outlay.

A further problem is the cooling of the component, since the heat loss of the windings has to be removed predominantly through a surrounding ferrite core. Ferrite material is a poor thermal conductor however, and a thermal connection over the entire surface on both sides to a heat sink is difficult to implement.

The implementation of the necessary insulation clearances without excessive enlargement of the leakage inductances is additionally problematic.

The object of the invention is to provide a transformer and an associated production method, which enable efficient cooling of the transformer with the lowest possible outlay.

The invention achieves this object by providing a transformer, and a production method therefor, for switched-mode power supplies. The transformer includes a magnetizable core having a winding axis, at least one primary winding, which is formed by a primary winding conductor that at least partly surrounds the winding axis of the core, and at least one secondary winding, which is formed by a secondary winding conductor. The secondary winding conductor surrounds the primary winding conductor, and is formed in one layer. A cross section of the secondary winding conductor is rectangular, in particular, square.

The transformer is preferably suitable or intended for switched-mode power supplies and has: a magnetic or magnetizable core, in particular a ferrite core, which defines a winding axis or has a winding axis, at least one primary winding, which is formed by a primary winding conductor, in particular in the form of a litz wire that is insulated a number of times, and which at least partly surrounds the winding axis of the core or a limb of the core, through which the winding axis runs, and at least one secondary winding, which is formed by a secondary winding conductor. The secondary winding conductor surrounds the primary winding conductor, that is to say the secondary winding conductor and the primary winding conductor form different winding layers over the winding axis. The secondary winding is formed in one layer, and a cross section of the secondary winding conductor is rectangular, in particular, square. Due to the cross section and the resultant outer contour, the secondary winding can be coupled very easily and with low thermal resistance to a cooling surface, for example. The cross section of the winding, which is solid in particular, or of the solid conductor, is intentionally overdimensioned here, such that an efficient heat flow is possible within the winding.

In an embodiment the secondary winding conductor is solid, that is to say the entire cross section of the conductor is filled with conductor material, or the conductor is filled completely with conductor material within its outer dimension. The conductor in particular is not constructed by interwoven stranded wires, by a plurality of combined individual conductors, or in the form of a hollow conductor or the like.

In an embodiment the at least one secondary winding is formed from a solid material block, which is structured to form the secondary winding conductor, in particular is structured by drilling, cutting and/or milling. Alternatively, the at least one secondary winding is formed from a diecast shaped article.

In an embodiment the transformer has a nominal output, wherein the (minimum) cross section of the secondary winding conductor is dimensioned in such a way that a current-carrying capacity of the secondary winding conductor is greater than is necessary for the nominal output, that is to say the cross section of the conductor is overdimensioned in relation to the nominal output.

In an embodiment the secondary winding conductor consists of copper or titanium, particularly preferably of aluminum.

In an embodiment a planar cooling element is provided, which is thermally coupled to the secondary winding, in particular to the side of the secondary winding facing away from the winding axis of the core. A heat-conductive electric insulator is preferably provided and is arranged between the cooling element and the secondary winding. The electric insulator is preferably an electrically insulating heat-conductive foil.

In accordance with the invention, the secondary winding or the secondary winding conductor forms a thermal bridge to the planar cooling element. Core losses and losses of the primary winding(s) pass initially to the secondary winding(s), for example in order to then be removed via the planar cooling element in the form of a water-cooled cooling plate.

In an embodiment the secondary winding forms a heat sink.

In an embodiment a distance between the primary winding and the core and a distance between the secondary winding and the primary winding are selected in such a way that leakages are minimized. In other words, the primary winding lies as tightly as possible over the core and the secondary winding lies as tightly as possible over the primary winding, such that there are minimal losses caused by leakage fields and good thermal coupling of the system is also achieved.

In the method for producing the above-mentioned transformer, the secondary winding is formed from a solid material block, which is structured to form the conductor, in particular as a result of material removing machining in the form of drilling, cutting and/or milling.

The invention will be described hereinafter with reference to the drawings, which illustrate preferred embodiments of the invention.

### BRIEF DESCRIPTION OF THE DRAWINGS

FIG. 1 shows schematically an illustration of a transformer according to the invention;

FIG. 2 shows schematically an exploded illustration of the transformer shown in FIG. 1; and

FIG. 3 shows schematically an electric equivalent circuit of the transformer shown in FIGS. 1 and 2.

### DETAILED DESCRIPTION OF THE DRAWINGS

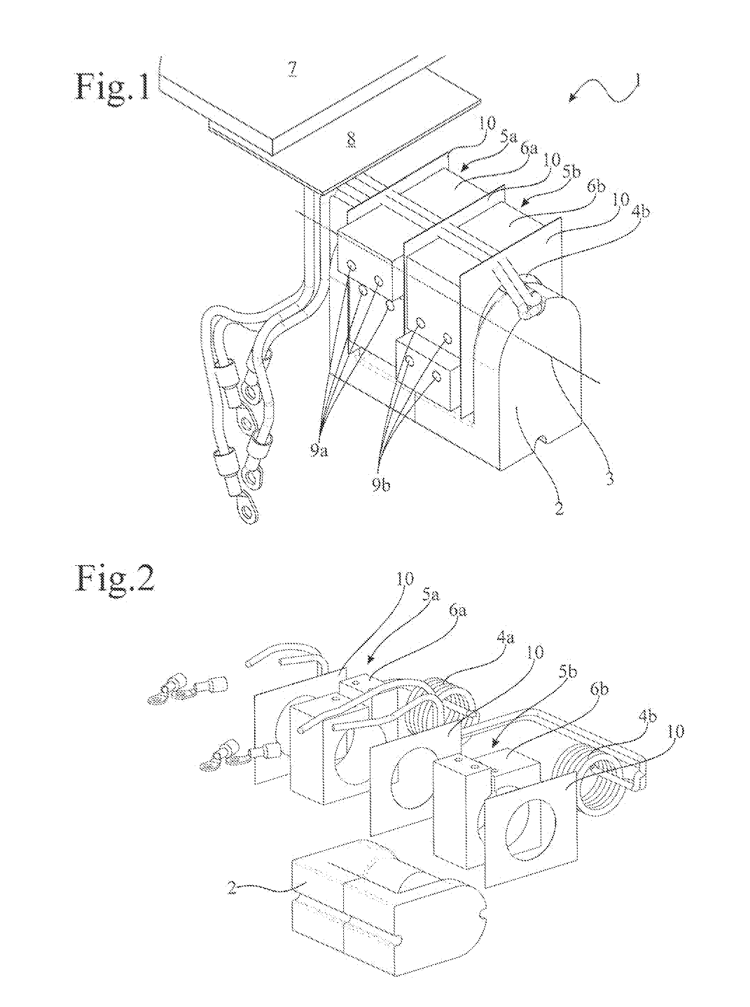

FIG. 1 shows a transformer 1 for switched-mode power supplies comprising a magnetizable ferrite core 2 having a limb that defines a winding axis 3, a first primary winding 4a (see FIG. 2), which is formed by a first primary winding conductor made of litz wires that are insulated a number of times and which directly surrounds the winding axis 3 of the core 2, a second primary winding 4b, which is formed by a second primary winding conductor made of litz wires that are insulated a number of times and which directly surrounds the winding axis 3 of the core 2. The first primary winding 4a and the second primary winding 4b are arranged axially adjacently on the limb. A first solid secondary winding 5a is made of aluminum and is formed by a first secondary winding conductor 6a, and a second solid secondary winding 5b is made of aluminum and is formed by a second secondary winding conductor 6b.

Furthermore, bores 9a and 9b are provided as connection points for the first and second secondary winding 5a and 5b, respectively.

Insulation elements 10 serve to electrically insulate between the primary and secondary circuit.

The secondary winding conductors 6a and 6b surround their associated primary winding conductors, such that they are arranged axially adjacently over the limb. The secondary winding conductors 6a and 6b are each formed in one layer and each have, in the winding direction, a rectangular cross section which is changeable in the winding direction.

The transformer has a specific nominal output, wherein the cross section of the secondary winding conductors 6a and 6b is dimensioned in such a way that the current-carrying capacity thereof is greater than is necessary for the nominal output.

For efficient cooling, a planar cooling element 7 is further provided, which is to be thermally coupled to the side or surface of the secondary windings 5a and 5b facing away from the winding axis 3 of the core 2. A heat-conductive electric insulator in the form of an electrically insulating heat-conductive foil 8 is provided between the cooling element 7 and the secondary windings 5a and 5b. Corresponding cooling elements can be provided on the upper face and/or the lower face of the secondary windings 5a and 5b.

The secondary windings 5a and 5b are each formed from a solid aluminum material block, which is suitably structured by drilling, cutting, electric discharge machining and/or milling.

The cross section of the secondary winding conductors 6a and 6b, or the minimum cross section thereof over the entire winding, is dimensioned in such a way that, at a given working frequency, the effective replacement area (skin depth) due to the skin effect is much smaller than the geometric cross section of the solid secondary winding conductors 6a and 6b. The dominating alternating current loss thus flows in the outer region of the winding in the direction of the core region of the winding and lastly along the winding to the heat sink in the form of the cooling element 7.

FIG. 2, for clarification, shows an exploded illustration of the transformer shown in FIG. 1.

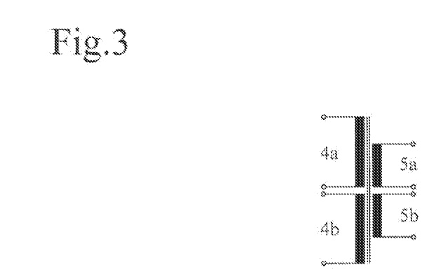

FIG. 3 shows an electric equivalent circuit of the transformer 1 shown in FIGS. 1 and 2 with the primary windings 4a and 4b and the secondary windings 5a and 5b.

The embodiments shown have solid secondary-side windings 5a and 5b, which lie directly over the primary windings 4a and 4b, respectively, which are formed from litz wires insulated a number of times. The primary windings 4a and 4b are arranged with minimal spacing over the ferrite core 2.

Due to straight surfaces of the solid secondary windings 5a and 5b, a simple and efficient coupling to the cooling surface 7 is possible. The (minimum) cross section of the solid secondary windings 5a and 5b is intentionally overdimensioned here in order to thus achieve an efficient heat flow within the secondary windings 5a and 5b. The windings 5a and 5b are insulated with respect to the cooling area 7 by way of a thin heat-conductive foil 8 or ceramic material.

Due to the minimal distances between the windings 4a, 4b, 5a and 5b and the transformer core 2, optimal cooling is ensured on the one hand, and on the other hand the leakages are minimized or the coupling between the primary and secondary side is maximized.

The shown embodiments enable simple cooling of the transformer 1 via the solid secondary windings 5a and 5b, which can be effectively thermally coupled.

The transformer core 2 may likewise be thermally coupled very easily, such that optimal cooling of the overall component is possible. Furthermore, due to the large cross section of the secondary windings 5a and 5b, aluminum can be used, which saves weight and costs.

The transformer 1 for switched-mode power supplies has at least one solid (secondary) winding, the cross section of which is selected in such a way that a transport of the heat loss produced during operation to a planar heat sink is possible without the need for additional coolants.

Of course, just one individual primary and secondary winding or more than two primary and secondary windings may also be provided.

1-13. (canceled)

14. A transformer for switched-mode power supplies, the transformer comprising:
a magnetizable core having a winding axis;
at least one primary winding formed by a primary winding conductor at least partly surrounding the winding axis of the core; and
at least one secondary winding formed by a secondary winding conductor, wherein
the secondary winding conductor surrounds the primary winding conductor,
the secondary winding is formed in one layer, and
a cross section of the secondary winding conductor is rectangular.

15. The transformer according to claim 14, wherein the cross section of the secondary winding conductor is square.

16. The transformer according to claim 14, wherein the secondary winding conductor is solid.

17. The transformer according to claim 16, wherein
the at least one secondary winding is formed from a solid material block, structured to form the secondary winding conductor, and
the structuring of the solid material block is carried out by material removing machining.

18. The transformer according to claim 17, wherein the material removing machining is at least one of drilling, cutting, milling or electric discharge machining.

19. The transformer according to claim 14, wherein the at least one secondary winding is formed from a diecast shaped article.

20. The transformer according to claim 14, wherein the transformer has a nominal output, the cross section of the secondary winding conductor being dimensioned such that a current-carrying capacity of the secondary winding conductor is higher than necessary for the nominal output.

21. The transformer according to claim 14, wherein the secondary winding conductor is formed of aluminum, copper, or titanium.

22. The transformer according to claim 14, further comprising:
a planar cooling element thermally coupled to the secondary winding.

23. The transformer according to claim 22, wherein the planar cooling element is thermally coupled to the secondary winding on a side of the secondary winding facing away from the winding axis of the core.

24. The transformer according to claim 23, further comprising:
a heat-conductive electric insulator arranged between the cooling element and the secondary winding.

25. The transformer according to claim 24, wherein the electric insulator is an electrically insulating heat-conductive foil.

26. The transformer according to claim 14, wherein the secondary winding forms a heat sink.

27. The transformer according to claim 14, wherein a distance between the primary winding and the core and a distance between the secondary winding and the primary winding are selected to minimize leakages.

28. A method for producing a transformer for switched-mode power supplies having a magentizable core with a winding axis, a primary winding formed by a primary winding conductor that at least partly surrounds the winding axis, and a secondary winding formed by a secondary winding conductor, the method comprising the acts of:
providing a solid material block to form the secondary winding; and
structuring the solid material block to form the secondary winding conductor, wherein a cross section of the secondary winding conductor is rectangular.

29. The method according to claim 28, wherein the structuring act is carried out by material removing machining of the solid material block via drilling, cutting, milling and/or electric discharge machining.
